(19) United States
(12) Patent Application Publication
(10) Pub. No.: US 2006/0101063 A1
(43) Pub. Date: May 11, 2006

(54) Method for the collection and analysis of medical data

(76) Inventors: Marshall Schreeder, (US); Shawn Bellina, (US); Devon Tuitt, (US)

Correspondence Address: BRADLEY ARANT ROSE & WHITE LLP, 200 CLINTON AVE. WEST, SUITE 900, HUNTSVILLE, AL, 35801, US

(21) Appl. No.: 11/268,254

(22) Filed: Nov. 7, 2005

Related U.S. Application Data
(60) Provisional application No. 60/626,087, filed on Nov. 5, 2004.

(51) Int. Cl. G06F 7/00

(52) U.S. Cl. 707/102

(57) ABSTRACT

A method of collecting and storing electronic medical data for analysis has been developed. The method includes intercepting medical billing information in an electronic format that is being electronically transmitted to a billing recipient; extracting identified medical data from the medical billing information; securely transmitting the medical billing information on the billing recipient; and storing the data in an electronic database for later retrieval.

### CROSS-REFERENCE TO RELATED APPLICATIONS

This application claims priority to U.S. Provisional Application No. 60/626,087 entitled “Method for the Collection and Analysis of Medical Data” that was filed on Nov. 5, 2004.

### BACKGROUND OF INVENTION

1. Field of the Invention

The invention relates generally to a business method for analyzing medical data. More specifically, the invention relates to a method for the collection and statistical analysis of medical data.

2. Background Art

Modern medical treatment of patients is increasingly complex. Often determining the large scale effectiveness of treatment schemes for diseases such as cancer is difficult. Such information is important to determining the most appropriate treatments that have the greatest chance of success. However, it is often difficult to obtain, compile and analyze data on large numbers of patients being treated in a similar manner. Typically, data such as clinical signals (defined as any representation in any media that describes the state of a patient's clinical condition at any given point in time), are collected manually and entered into a paper or electronic file or through machine automation in the case of diagnostic machinery. Aggregating data from multiple clinical sites for the purposes of study is time consuming, expensive and highly inaccurate. Consequently, a need exists for a method of automatically collecting and analyzing heterogeneous clinical signals and other medical data of patients.

### SUMMARY OF INVENTION

In some aspects, the invention relates to a method of collecting electronic medical data, comprising: receiving medical billing information in an electronic format that is being electronically transmitted to a billing recipient; extracting identified medical data from the medical billing information; sending the medical billing information on the billing recipient; and storing the identified medical data in an electronic database.

In other aspects, the invention relates to a method of collecting electronic medical data, comprising: step for electronically intercepting medical billing information, where the medical billing information is in an electronic format; step for extracting protected health information from the medical billing information; step for extracting identified medical data from the medical billing information; and step for storing the identified medical data in an electronic data base.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows a block diagram one embodiment of the present invention with a data tap that extracts relevant medical data from a data communications stream.

FIG. 2 shows a schematic diagram of embodiment of the present invention with a data tap.

### DETAILED DESCRIPTION

A method for collecting and analyzing medical data is disclosed. In practice, the present invention will automatically acquire a patient's clinical or administrative data from structured or unstructured electronic sources. The data to be extracted may include but is not limited to: patient demographics (age, sex, height, weight, etc.) and condition; medications; any treatment scheme or “protocol” such as a specific chemotherapy regimen; and any other individual or clinical patient data that may be valuable for analysis. Further examples of data sources include notes regarding patient progress report, lab results, consultations, imaging, treatment plans, discharge summaries, pathology, histology, biometrics, genomic information, etc. The data may be discrete values, objective data, or subjective comments. Patient privacy is protected by automatically filtering and extracting any sensitive information prior to storing the data. This is intended to ensure compliance with privacy laws and regulations that protect individual medical records.

Some medical facilities such as physician practice groups, hospitals, research universities, etc. maintain medical records in electronic form. However, these clinical data sources are kept in a wide variety of formats. There is no uniformity across the data storage formats. Information that may be of interest is usually not stored or categorized in the same machine location or file format. However, when medical facilities such as physician practice groups transmit the billing invoices for their services, the information is configured in a specific format that is often unique to each recipient. The recipients of the billing data such as insurance companies as well as governmental agencies mandate these unique formats. For example, the federal government has standardized the way that medical facilities transmit their billing invoices to Medicare and Medicaid called the X-12 format. It is anticipated that electronic pharmaceutical prescriptions may adopt a uniform data format. It is intended that the present invention may be used to extract medical data from such electronic prescriptions as well.

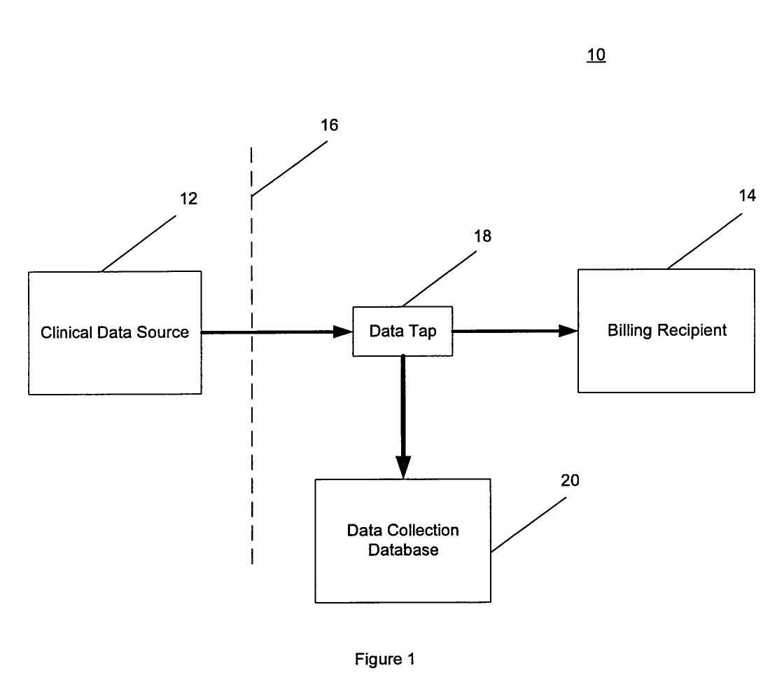

The present invention involves a method of collecting medical data by placing a “data tap” outside the network containing the clinical data source. When the billing requests are prepared in the prescribed format and sent to the paying entity, the data tap scans the records for desired medical information and extracts the data to a separate database for storage and analysis. FIG. 1 shows a block diagram 10 one embodiment of the present invention with a data tap that extracts relevant medical data from a data communications stream. The clinical data source 12 prepares and sends billing invoices to a billing recipient 14 such as an individual, an insurance company, a government agency, or corporate entity for payment. A data tap 18 is located outside the clinical data source network boundary 16. The billing invoice passes through the data tap 18 where the medical information from the billing invoice is extracted and sent to the collection database 20. At the data tap 18, the data is extracted of all protected health information (PHI) that is protected by confidentiality laws such as HIPAA. In this mode of operation, the data tap 18 functions as a data filter that prevents PHI from accidentally being disclosed.

In some embodiments, there is two-way communication between the database 20 and the data tap 18 so that the data tap 18 can be instructed to only collect specified types of data. Examples of data to be collected include clinical study endpoints and cancer treatment protocols. Any data that may be used for clinical, biotechnical, epidemiological, and financial research may also be collected. For example, the data can be used to identify possible patients for participation in clinical trials. Additional uses for data include creating baseline health data for specific areas, actuarial analysis, and marketing purposes. The collected data may also be used to profile individual physician's performance patterns in order to suggest more effective economical procedures. As genetic mapping becomes more common, the data collected can be used to establish a databank of statistical information to identify potential patients for gene specific therapies.

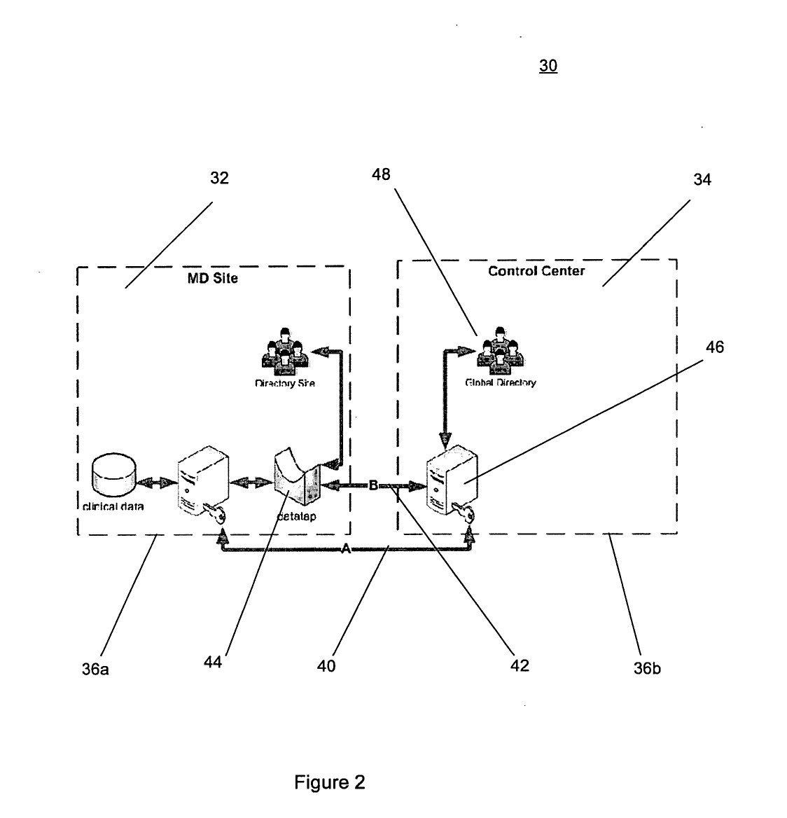

FIG. 2 shows a schematic drawing 30 of another embodiment of the present invention. As shown, a physician's security domain (MD Site) 32 is linked to a control center (Control Center) 34 with either: (i) a secure boundary 36a to boundary 36b link 40, between the physician's security domain 32 and the control center 34, or (ii) a secure tunnel 42 between the data tap 44 in the physician's security domain 32 connected to a receiver 46 located at the control center. Directory data gathered via either of the path shown in (i) or (ii) are deposited in the Global Directory 48. Directory data define metadata specific to a given patient, data such as identifying numbers, billing information and last known clinical information (lab values).

Data stored in the directory is bounded by standard directory security, so that access privileges can be controlled by the submitting physician's security domain. Authorized recipients are allowed to access and view protected health information, while other approved recipients who have insufficient security privileges are allowed to access and view general data that have all PHI extracted. The data may be used to analyze the performance of pharmaceuticals, medical devices or other medical treatment or diagnostic protocols to determine such things as efficacy, side effects, outcomes, etc. While the example shown in FIG. 2 illustrates collecting relevant medical data from a physician's domain, it should be clear that these techniques could be used at other domains such as universities, hospitals, medical outpatient facilities, pharmacies, insurance companies, financial institutions, and governmental agencies.

The present invention has the advantages over the prior art of automatically collecting and aggregating data from a physician's records while the patient's privacy is protected by extracting any identifying information. This allows users of the invention to examine data from across a wide spectrum of patients and extrapolate valuable information. While the invention has been described with respect to a limited number of embodiments, those skilled in the art, having benefit of this disclosure, will appreciate that other embodiments can be devised which do not depart from the scope of the invention as disclosed here.

What is claimed is:

1. A method of collecting electronic medical data, comprising:
receiving medical billing information in an electronic format that is being electronically transmitted to a billing recipient;
extracting identified medical data from the medical billing information;
sending the medical billing information on the billing recipient; and
storing the identified medical data in an electronic database.

2. The method of claim 1, where the medical billing information is generated by a physician.

3. The method of claim 1, where the medical billing information is generated by a hospital.

4. The method of claim 1, where the billing recipient is an insurance company.

5. The method of claim 1, where the billing recipient is a government agency.

6. The method of claim 1, where the billing recipient is a corporate payor.

7. The method of claim 1, where the billing recipient is an individual.

8. The method of claim 1, where the medical billing information is received by a data tap.

9. The method of claim 1, where the identified medical data is stored in a global directory.

10. The method of claim 9, where the global directory is bounded by directory security.

11. The method of claim 1, where protected health information is extracted of the medical billing information before it is copied.

12. The method of claim 11, where access to protected health information is limited to authorized users.

13. The method to claim 1, where medical billing information is generated in X12 format.

14. The method to claim 1, where medical billing information is referenced using Lightweight Directory Access Protocol (LDAP) framework.

15. A method of collecting electronic medical data, comprising:
step for electronically intercepting medical billing information, where the medical billing information is in an electronic format;
step for extracting protected health information from the medical billing information;
step for extracting identified medical data from the medical billing information; and
step for storing the identified medical data in an electronic data base.
